(19) United States
(12) Patent Application Publication
(10) Pub. No.: US 2025/0029008 A1
(43) Pub. Date: Jan. 23, 2025

(54) SYSTEM AND METHOD FOR GENERATING REALISTIC DEFECTIVE DATA SAMPLES

(71) Applicant: Darwin AI ULC, Vancouver (CA)

(72) Inventors: Mohammad Javad Shafiee, Kitchener (CA); Alexander Sheung Lai Wong, Waterloo (CA); Francis Li, Toronto (CA); Saad Rasheed Abbasi, Waterloo (CA); Seyed Mahmoud Famouri, Waterloo (CA); Xiao Yu Wang, Waterloo (CA)

(21) Appl. No.: 18/778,714

(22) Filed: Jul. 19, 2024

Related U.S. Application Data
(60) Provisional application No. 63/528,180, filed on Jul. 21, 2023.

(51) Int. Cl. G06N 20/00

(52) U.S. Cl. CPC G06N 20/00

(57) ABSTRACT

Disclosed are systems and methods for generating realistic defective data samples. An example system for generating realistic defective data samples includes a scenario generator unit configured to generate defect scenario data. The example system includes a prompt generator unit configured to generate prompts based on the defect scenario data. The example system includes a simulator unit configured to generate simulation data based on the defect scenario data and digital twins data. The example system includes a digital twins data bank unit configured to store digital representations of real-world entities and a generative machine learning unit configured to generate a realistic defective data sample based on the simulation data and the prompts.

### CROSS-REFERENCE TO RELATED APPLICATIONS

This application claims the benefit of U.S. Provisional Patent Application No. 63/528,180, filed Jul. 21, 2023 entitled “SYSTEM AND METHOD FOR GENERATING REALISTIC DEFECTIVE DATA SAMPLES,” the disclosures of which are incorporated herein by reference in their entireties.

### TECHNICAL FIELD

The disclosure relates generally to the field of artificial intelligence (AI) and machine learning, and specifically and not by way of limitation, some embodiments are related to the generation of synthetic data for training machine learning algorithms.

### BACKGROUND

Machine learning, particularly deep learning, has emerged as an invaluable tool for automating various tasks, including the inspection of manufactured parts for defects. These automated inspection systems are widely used in industries such as electronics manufacturing, automotive production, and aerospace manufacturing to ensure that the produced parts meet the required quality standards.

Training machine learning algorithms for inspection tasks requires substantial datasets of defective and non-defective parts. Collecting a large dataset of real-world defective samples is often challenging, time-consuming, and costly, as it involves intentionally manufacturing defective parts or waiting for them to occur during the production process. Furthermore, the variety of defects that can occur in real-world scenarios is vast, and collecting samples that cover all possible defects is practically impossible. As a result, there has been a growing interest in generating synthetic defective data samples to complement real-world datasets.

Generative models, such as Generative Adversarial Networks (GANs), have been used to generate synthetic data samples. However, a common limitation of existing generative models is that they often produce visually appealing but unrealistic and implausible defective data samples. Such samples do not accurately represent the complexities and nuances of real-world defects, leading to poor generalization of the trained algorithms to real-world scenarios.

Another challenge is the lack of control over the generated synthetic data. For instance, it is often desirable to generate synthetic data samples with specific types of defects, or defects located in particular regions of the part. Existing generative models do not provide sufficient control over these aspects.

Therefore, there is a need for a system and method that can generate realistic synthetic defective data samples, which accurately mimic real-world defects, and provide fine control over the characteristics and properties of the generated defects. Such a system would significantly enhance the effectiveness of machine learning algorithms for inspecting parts for defects by training them with a rich and diverse dataset that closely resembles real-world scenarios.

### SUMMARY

In one example implementation, an embodiment includes generation of synthetic data for training machine learning algorithms.

Disclosed are example embodiments of a system for generating realistic defective data samples. The system includes a scenario generator unit configured to generate defect scenario data. The system also includes a prompt generator unit configured to generate prompts based on the defect scenario data. Additionally, the system includes a simulator unit configured to generate simulation data based on the defect scenario data and digital twins data. The system also includes a digital twins data bank unit configured to store digital representations of real-world entities. Additionally, the system includes a generative machine learning unit configured to generate a realistic defective data sample based on the simulation data and the prompts.

Disclosed are example embodiments of a method for generating realistic defective data samples. The method includes generating defect scenario data using a scenario generator unit. The method also includes generating prompts based on the defect scenario data using a prompt generator unit. Additionally, the method includes generating simulation data based on the defect scenario data and digital twins data using a simulator unit. The method also includes storing digital representations of real-world entities in a digital twins data bank unit. Additionally, the method includes generating a realistic defective data sample based on the simulation data and the prompts using a generative machine learning unit.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a schematic block diagram illustrating an embodiment of the system for generating realistic defective data samples, depicting the interaction among various units including the scenario generator unit, prompt generator unit, simulator unit, digital twins data bank unit, and generative machine learning unit.

FIG. 2 is a schematic block diagram illustrating an application-specific example of the system presented in FIG. 1, tailored for generating realistic electronic component defect samples.

FIG. 3 is a flowchart illustrating the steps involved in generating realistic defective data samples according to an embodiment of the disclosed method, including the generation of defect scenario data, prompt generation, simulation, and the generation of realistic defective samples by the generative machine learning unit.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

As discussed above, the present invention pertains to the field of artificial intelligence and machine learning, and more particularly to the generation of synthetic data for training machine learning algorithms. Some embodiments may have a focus on generating realistic defective data samples that simulate real-world scenarios for applications in quality control and inspection of manufactured parts.

Disclosed are systems and methods for generating realistic defective data samples for improving the performance of machine learning algorithms used in the inspection of parts for defects. In one embodiment, an example system may include a scenario generator unit, a prompt generator unit, a simulator unit, a digital twins data bank unit, and a generative machine learning unit. The scenario generator unit generates defect scenario data, which is used by the prompt generator unit to create prompts. The simulator unit uses the defect scenario data and digital twins data from the digital twins data bank unit to create simulation data. The generative machine learning unit uses the prompts and simulation data to generate realistic defective data samples. The system enables fine control over the generation of defective data samples and the production of samples that reflect real-world scenarios.

The performance of machine learning algorithms for inspecting parts to identify defects may depend heavily on the quantity and quality of data samples used to train such algorithms. One method for improving the performance of such machine learning algorithms is to generate defective data samples with which to train them, either in addition to real defective data samples or using just the generated defective data samples. The data generation process can be performed by training a generative machine learning system to generate defective data samples. However, one limitation with existing generative machine learning systems is that they generate visually appealing but unrealistic and implausible defective data samples that do not reflect real-world scenarios. Furthermore, existing generative machine learning systems do not allow for the level of fine control of where and how the defects are formed and the camera placement relative to the defective part in a generated defective data sample which may be necessary for producing good samples to train an algorithm with. As such, a system and method for generating realistic defective data samples that reflect real-world scenarios and allow for fine control over where and how the defects are formed and the camera placement relative to the defective part is highly desired.

The present disclosure relates generally to the field of machine learning and more specifically to systems and methods for generating realistic defective data samples. Generally, the systems and methods described herein may encompass a combination of one or more of the following: a scenario generator unit, a generative machine learning unit, a digital twins data bank unit, a prompt generator unit, and a simulator unit, to allow for the generation of a realistic defective data sample that reflects real-world defects. The scenario generator unit, generative machine learning unit, digital twins data bank unit, prompt generator unit, and simulator unit may take on the form of a digital hardware unit or a number of different digital hardware units or one or more digital signal processor units, one or more processors, one or more microprocessors, and/or digital logic, such as discrete digital logic, programmable logic, or other circuitry. The scenario generator unit, generative machine learning unit, digital twins data bank unit, prompt generator unit, and simulator unit may enable improved training of machine learning algorithms for inspection of parts for defects and may reduce the need for a larger quantity of high-quality defective data samples by providing the ability to generate additional realistic defective data samples for the algorithm to learn from.

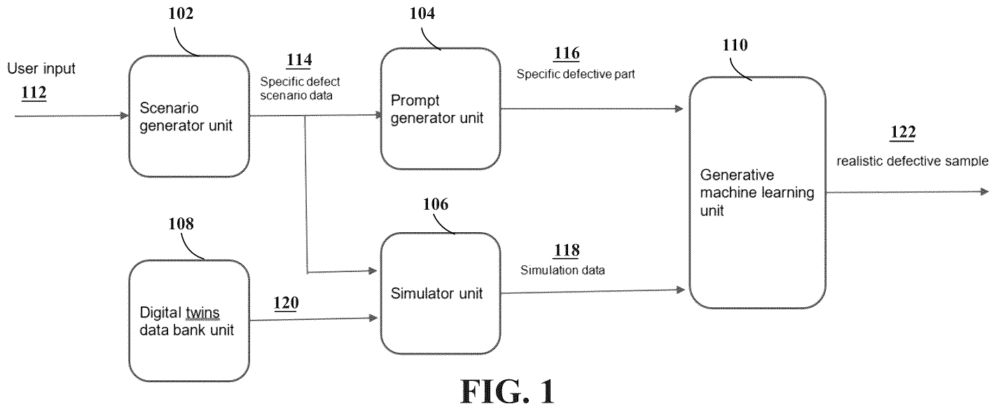

FIG. 1 is a schematic block diagram illustrating an embodiment of the system for generating realistic defective data samples, depicting the interaction among various units including the scenario generator unit, prompt generator unit, simulator unit, digital twins data bank unit, and generative machine learning unit. In general terms, the present systems and methods in accordance with various embodiments may include one or more of the following: a scenario generator unit 102, a prompt generator unit 104, and a simulator unit 106, a digital twins data bank unit 108, a generative machine learning unit 110. In an illustrative embodiment of the systems and methods, the scenario generator unit 102 may generate data related to a specific defect scenario automatically or generate data for a specific defect scenario based on a user input prompt 112. The defect scenario data 114 may be fed into the prompt generator unit 104 to generate a prompt 116 that describes the specific defective part characteristics to instruct the generative machine learning unit 110 on how to produce a defective data sample. The defect scenario data 114 may also be fed into the simulator unit 106, which may generate simulation data 118 based on the defect scenario data as well as from digital twins data 120 stored in the digital twins data back unit 108. The simulation data 118 and the generated prompt 116 may be fed into the generative machine learning unit 110, which then may generate a realistic defective sample 122.

More specifically, in an illustrative embodiment of FIG. 1, the scenario generator unit 102 may generate a specific defect scenario data automatically or based on a user input prompt. In an embodiment, the user input prompt may be in the form of a natural language input prompt as one or more sentences. Example input prompts include but are not limited to: “A skewed 331 resistor skewed by around 30 degrees on a green PCB board,” “A SMT capacitor rotated 90 degrees on a blue PCB board,” “a connector with 180 degrees rotated on a red PCB board,” “Two 5 mOhms capacitors with a wrong orientation from a red PCB board,” and “A straight-line scratch on the laptop casing in the bottom left-hand corner.” It should be noted that the example input prompts are not limited to those that are related to PCBs and are shown for illustrative purposes, only, and other input prompts related to other areas and fields and topics may be used. For example, the user prompt “A straight-line scratch on the laptop casing in the bottom left-hand corner,” “A dent on the surface of tablet,” and “A curved long scratch on surface of a cellphone” are not PCB related.

When a user input prompt is fed into the scenario generator unit, then the scenario generator unit may generate a specific defect scenario data based directly on this user prompt. When a user input prompt is not fed into the scenario generator unit, then the scenario generator unit generates a random scenario (for example, but not limited to, “An IC chip sitting skewed between 10 degrees and 20 degrees on a blue PCB board.”) and generates the corresponding specific defect scenario data. A random number generator within the scenario generator unit may be used to generate random numbers for determining the combination of concepts for forming a defect scenario (e.g., type of component, type of defect, direction of defect, type of PCB board, or any other defect scenario.) It should be noted that the implementation of the present systems and methods are not limited to the aforementioned method for generating defect scenario data, and other defect scenario data generation methods may be used in other embodiments.

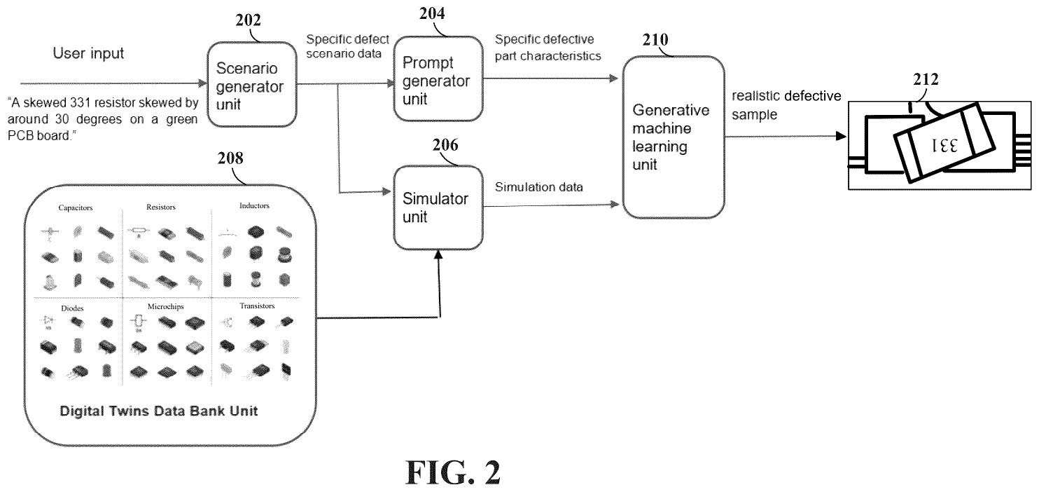

FIG. 2 is a schematic block diagram illustrating an application-specific example of the system presented in FIG. 1, tailored for generating realistic electronic component defect samples. The illustrated example of FIG. 2 may include a scenario generator unit 202, a prompt generator unit 204, a simulator unit 206, a digital twins data bank unit 208, and a generative machine learning unit 210. In FIG. 2, an application-specific example of the system presented in FIG. 1 is displayed. This figure is tailored to demonstrate the generation of realistic electronic component defect samples. This figure is similar to FIG. 1, but it includes additional details pertinent to the electronic component application, including example data types and specific digital twins that might be relevant in the electronic components domain.

In an embodiment, the generated specific defect scenario data is in the form of natural language (e.g., “A skewed 331 resistor skewed by around 30 degrees on a green PCB board” (see resistor 212)). In another embodiment, the generated specific defect scenario data is in the form of a set of numbers indicating a set of scenario parameters (e.g., a number representing type of component, a number representing type of defect, a number representing direction of defect, a number representing type of PCB board, etc.) It should be noted that the implementation of the present system and method is not limited to the aforementioned forms of defect scenario data, and other forms of defect scenario data may be used in other embodiments.

The defect scenario data is fed into prompt generator unit 202 to generate a prompt that describes the specific defective part characteristics to instruct the generative machine learning unit 210 on how to produce a defective data sample. In an embodiment, the prompt to the generative machine learning unit is a natural language prompt (e.g., “A skewed 331 resistor skewed by around 30 degrees on a green PCB board”), in which case the prompt generator takes the specific defect scenario data and converts it to a natural language prompt. In an embodiment, the conversion may be performed using a look-up table. In another embodiment, the conversion may be performed using a deep neural network. It should be noted that the implementation of the present systems and methods are not limited to the aforementioned methods for conversion, and other methods for conversion may be used in other embodiments. In another embodiment, the prompt to the generative machine learning unit may be a numerical prompt (e.g., a number representing type of component, a number representing type of defect, a number representing direction of defect, a number representing type of PCB board, or other types of defects.), in which case the prompt generator may take the specific defect scenario data and converts the specific defect scenario data to a numerical prompt. Similar to the example above, in an embodiment, the conversion may be performed using a look-up table. In another embodiment, the conversion may be performed using a deep neural network. It should again be noted that the implementation of the present systems and methods are not limited to the aforementioned methods for conversion, and other methods for conversion may be used in other embodiments. Furthermore, it should be noted that the implementation of the present system and method is not limited to the aforementioned method for generating prompts, and other methods for generation prompts may be used in other embodiments.

The specific defect scenario data may be fed into the simulator unit 206, which may generate simulation data based on the defect scenario data as well as from digital twins data stored in the digital twins data bank unit 208. Here, a digital twin refers to a digital representation of a real-world entity. The digital twin may take on different forms including but not limited to: images, videos, volumetric scans, 3D models, point clouds, neural networks. The simulator unit 206 may retrieve the appropriate digital twins based on the input specific defect scenario data and simulates the defect scenario using the retrieved digital twins as well as the input specific defect scenario data. For example, the simulator may run a simulation with a green PCB board and a resistor placed on the green PCB board at a skewed angle of 30 degrees based on the input specific defect scenario data and retrieved digital twin of a resistor and a retrieved digital twin of a green PCB board from the digital twins data bank unit 208. The output results of the simulation may be simulation data that may be take on different forms including but not limited to: images, videos, volumetric scans, 3D models, point clouds, neural networks. It should be noted that the implementation of the present system and method is not limited to the aforementioned methods for simulation, and other methods for simulation may be used in other embodiments.

The simulation data and the generated prompt may be fed into the generative machine learning unit 210, which may then generate a realistic defective sample, e.g., the resistor 212. In an embodiment, the generative machine learning unit 210 may be a latent diffusion neural network model that takes the simulation data and generated prompt as input embeddings and performs a reverse diffusion process to reconstruct a realistic defective sample, taking those embeddings into account. In another embodiment, the generative machine learning unit 210 may be a generative adversarial network, where the generator network may be used to reconstruct a realistic defective sample based on the simulation data and generated prompt. It should be noted that the implementation of the present system and method is not limited to the aforementioned methods for generating realistic defective samples, and other methods for generating realistic defective samples may be used in other embodiments.

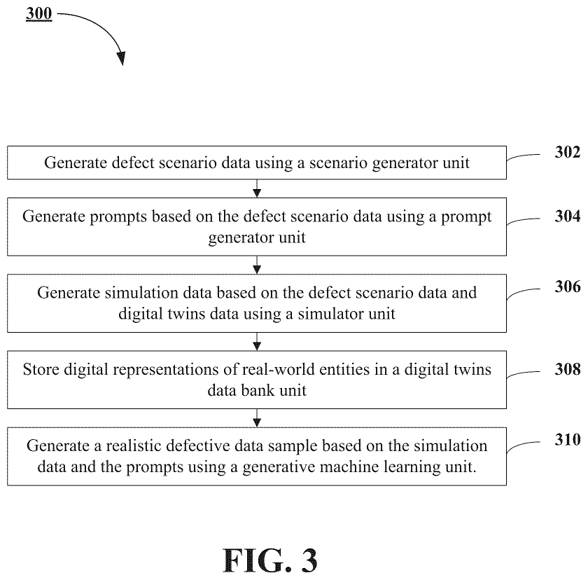

FIG. 3 illustrates a flowchart showing the steps involved in generating realistic defective data samples according to an embodiment of the disclosed method. It begins with the generation of defect scenario data (302), followed by the prompt generation (304), generation of simulation data (306), storage of a digital representation of real-world entities in a digital twins data-bank, and finally, the generation of realistic defective samples (310) by the generative machine learning unit.

In the method for generating realistic defective data samples, the following steps may be undertaken in a coordinated manner to ensure that the data generated is not only realistic but also tailored to specific scenarios and requirements. Below is a discussion of the flow diagram representing the steps 302, 304, 306, 308, 310.

The method for generating realistic defective data samples includes generating defect scenario data using a scenario generator unit (302). In an example embodiment, the defect scenario data may be generated based on user input. In another example embodiment, the defect scenario data is generated automatically without user input. In another example embodiment, the defect scenario data is in the form of natural language or a set of numbers indicating a set of scenario parameters. In this initial step, the Scenario Generator Unit is used to create defect scenario data. The defect scenario data represents various scenarios in which a defect can occur. This data is vital as it forms the basis for the realistic defective data samples that will be generated. Users can input specific requirements or conditions to tailor the scenarios according to their needs.

The method for generating realistic defective data samples includes generating prompts based on the defect scenario data using a prompt generator unit (304). In an example embodiment, the prompts generated by the prompt generator unit are dynamically adjusted based on real-time feedback from the simulation data to create more realistic and varied defective data scenarios. The next step involves creating prompts which may be questions or instructions based on the defect scenario data generated in step 1. These prompts are created by the Prompt Generator Unit and may be needed in guiding the Simulator Unit in the next step. Prompts help in narrowing down the specific aspects of the defect scenarios that the user wants to simulate and eventually generate realistic defective data samples for.

The method for generating realistic defective data samples includes generating simulation data based on the defect scenario data and digital twins data using a simulator unit (306). In an example embodiment, the digital twins data bank unit stores digital representations in forms including but not limited to images, videos, volumetric scans, 3D models, point clouds, or neural networks. In another example embodiment, the digital twins data bank unit is further configured to periodically update the stored digital representations with real-world performance data, to ensure that the digital twins accurately reflect the current state of the real-world entities.

Generating Simulation Data based on the Defect Scenario Data and Digital Twins Data using a Simulator Unit: In this step, the Simulator Unit makes use of the prompts generated in step 2 and the digital twins stored in step 3 to generate simulation data. This simulation data represents the behavior or properties of the digital twins under the defect scenarios outlined in the prompts. The simulator will try to predict how a real-world entity would react or behave if it were in the situation described in the defect scenario data.

The method for generating realistic defective data samples includes storing digital representations of real-world entities in a digital twins data bank unit (308). In parallel, digital representations of real-world entities known as digital twins are stored in a Digital Twins Data Bank Unit. These digital twins may be highly detailed and accurate models that replicate the properties and behaviors of their real-world counterparts. They may be used to generate realistic simulation data as they represent the subjects on which defects are to be simulated.

The method for generating realistic defective data samples includes generating a realistic defective data sample based on the simulation data and the prompts using a generative machine learning unit (310). In an example embodiment, the generative machine learning unit is a latent diffusion neural network model or a generative adversarial network.

In an example embodiment, the simulator unit is further configured to incorporate environmental factors such as temperature, humidity, and vibration in the simulation data, to mimic real-world conditions that may contribute to the defects. In an example embodiment, the generative machine learning unit includes a validation component that compares the generated realistic defective data sample against a repository of known defect patterns to assess the accuracy and reliability of the generated data.

Finally, the Generative Machine Learning Unit is used to create a realistic defective data sample based on the simulation data generated in step 4 and the prompts from step 2. This machine learning unit is capable of understanding complex patterns and generating new data that is not in its training set but is still realistic. It generates the final output, which is the realistic defective data sample, which can then be used for various applications like testing, analysis, or training models.

This flow diagram highlights a systematic and efficient approach to generating realistic defective data samples by integrating various units and leveraging digital twins and machine learning. Such an approach can be very valuable in industries where testing on real-world entities is either too expensive, dangerous, or impractical.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A system for generating realistic defective data samples comprising:
a scenario generator unit configured to generate defect scenario data;
a prompt generator unit configured to generate prompts based on the defect scenario data;
a simulator unit configured to generate simulation data based on the defect scenario data and digital twins data;
a digital twins data bank unit configured to store digital representations of real-world entities; and
a generative machine learning unit configured to generate a realistic defective data sample based on the simulation data and the prompts.

2. The system of claim 1, wherein the scenario generator unit generates defect scenario data based on user input.

3. The system of claim 1, wherein the scenario generator unit generates defect scenario data automatically without user input.

4. The system of claim 1, wherein the defect scenario data is in the form of natural language or a set of numbers indicating a set of scenario parameters.

5. The system of claim 1, wherein the digital twins data bank unit stores digital representations in forms including but not limited to images, videos, volumetric scans, 3D models, point clouds, or neural networks.

6. The system of claim 5, wherein the digital twins data bank unit further includes metadata associated with each digital representation, including information such as manufacturing date, materials, and past maintenance history.

7. The system of claim 1, wherein the generative machine learning unit is a latent diffusion neural network model or a generative adversarial network.

8. The system of claim 1, wherein the prompt generator unit is further configured to generate prompts based on historical defect data, allowing for the simulation of scenarios that replicate past occurrences.

9. The system of claim 1, wherein the simulator unit is configured to run multiple simulations with varying parameters and conditions to generate a diverse range of simulation data for different defect scenarios.

10. The system of claim 1, wherein the generative machine learning unit is further configured to evaluate the realism and relevance of the generated defective data samples using an evaluation module that provides feedback to refine subsequent simulations.

11. A method for generating realistic defective data samples comprising the steps of:
generating defect scenario data using a scenario generator unit;
generating prompts based on the defect scenario data using a prompt generator unit;
generating simulation data based on the defect scenario data and digital twins data using a simulator unit;
storing digital representations of real-world entities in a digital twins data bank unit; and
generating a realistic defective data sample based on the simulation data and the prompts using a generative machine learning unit.

12. The method of claim 11, wherein the defect scenario data is generated based on user input.

13. The method of claim 11, wherein the defect scenario data is generated automatically without user input.

14. The method of claim 11, wherein the defect scenario data is in the form of natural language or a set of numbers indicating a set of scenario parameters.

15. The method of claim 11, wherein the digital twins data bank unit stores digital representations in forms including but not limited to images, videos, volumetric scans, 3D models, point clouds, or neural networks.

16. The method of claim 15, wherein the digital twins data bank unit is further configured to periodically update the stored digital representations with real-world performance data, to ensure that the digital twins accurately reflect the current state of the real-world entities.

17. The method of claim 11, wherein the generative machine learning unit is a latent diffusion neural network model or a generative adversarial network.

18. The method of claim 11, wherein the prompts generated by the prompt generator unit are dynamically adjusted based on real-time feedback from the simulation data to create more realistic and varied defective data scenarios.

19. The method of claim 11, wherein the simulator unit is further configured to incorporate environmental factors such as lighting, camera position, and vibration in the simulation data, to mimic real-world conditions that may contribute to the defects appearance.

20. The method of claim 11, wherein the generative machine learning unit includes a validation component that compares the generated realistic defective data sample against a repository of known defect patterns to assess the accuracy and reliability of the generated data.
